(19) United States
(12) Patent Application Publication
(10) Pub. No.: US 2010/0161524 A1
(43) Pub. Date: Jun. 24, 2010

(54) METHOD AND SYSTEM FOR IDENTIFYING GRAPHICAL MODEL SEMANTICS

(75) Inventors: David Amid, Kiryat Ata (IL); Ateret Anaby-Tavor, Givat Ada (IL); Zohar Feldman, Haifa (IL); Amit Fisher, Nofit (IL)

Correspondence Address: SCULLY, SCOTT, MURPHY & PRESSER, P.C., 400 GARDEN CITY PLAZA, SUITE 300, GARDEN CITY, NY, 11530, US

(73) Assignee: International Business Machines Corporation, Armonk, NY (US)

(21) Appl. No.: 12/339,458

(22) Filed: Dec. 19, 2008

(51) Int. Cl. G06F 15/18; G06N 5/02; G06F 17/30

(52) U.S. Cl. 706/12; 706/47; 706/55; 706/52; 707/E17.048; 707/E17.046

(57) ABSTRACT

A system and method for identifying graphical model semantics, one aspect, receive a graphical diagram, associate each of a plurality of elements with one or more predetermined meta-types, identify a plurality of types in the graphical diagram, and determine a category for each of elements in said graphical diagram. Containment identification rules identify one or more containment relationships in the graphical diagram. Multiplicity identification rules identify multiplicity relationships in the graphical diagram. Advanced semantic rules identify visual elements that represent attributes and refine relationships to identify unique behavior.

### CROSS-REFERENCE TO RELATED APPLICATIONS

This application is related to U.S. patent application Ser. No. ______ entitled, “MODELING TOOL BUILDER—GRAPHICAL EDITOR CONSTRUCTION,” (attorney docket IL920080047US1 (22482)), filed on Dec. 19, 2008 and assigned to the same assignee in the present application, contents of which are incorporated by reference herein in its entirety.

### FIELD OF THE INVENTION

The present disclosure is related to modeling tools, and more particularly to inferring or identifying the semantics from a graphical model.

### BACKGROUND OF THE INVENTION

Conventional modeling tools allow the user to model specific model types intended by the tool. On the other hand, meta modeling tools allow the user to create a modeling tool, provided that the user supplies the semantics (meta model) explicitly. The present disclosure addresses the problem of inferring the semantics from a graphical model (or models), that represent possible instance of the model type.

U.S. Pat. No. 6,988,062 discloses meta model generation on the basis of examples of target models, and addresses meta models which represent directed multi graph models. That patent, however, is not concerned with extracting the meta model from drawings or diagrams other than those that are in the form of nodes and edges.

U.S. Pat. No. 7,240,327 discloses creating a meta-data for a modeling tool from the instance information for pre-defined object types input in a GUI. “MetaBuilder: the diagrammer's diagrammer” by R. I. Ferguson and A. Hunter discloses generating a meta model by drawing items in a specific notation. The meta model is further used for automatically generating a target tool. The notation is based upon the concept of a mathematical graph consisting of nodes and edges.

U.S. Pat. No. 7,096,454 discloses a method for creating models using gestures drawn by user. The gesture is interpreted based on a meta-model and an algorithm creates or modifies model elements based on the interpretations. WO06106495A1 discloses generating a meta model from a data model by extracting meta data from an existing data model. U.S. Patent Application Publication 2005/0160401A1 discloses customizing a modeling tool according to user's needs. U.S. Pat. No. 7,000,219 discloses developing a software system using a metamodel.

“Using meta-modelling and graph grammars to create modelling environments” by De Lara Jaramillo, Juan; Vangheluwe, Hans; and Moreno, Manuel Alfonseca discloses combined use of meta-modeling and graph grammars for the generation of visual modeling tools for simulation formalisms.

### BRIEF SUMMARY OF THE INVENTION

A method and system for identifying graphical model semantics are provided. The method, in one aspect, may comprise receiving a graphical diagram and associating each of a plurality of elements in the graphical diagram with one or more predetermined meta-types. The method may also comprise identifying a plurality of types and determining a category for the plurality of types. The method may further comprise executing containment relationship identification rules to identify one or more containers in the graphical diagram and executing multiplicity identification rules to identify multiplicity relationships in the graphical diagram. The method may further comprise executing advanced semantic rules to identify visual elements that represent attributes and refine relationships between the plurality of types to identify unique behavior.

A system for identifying graphical model semantics, in one aspect, may comprise a module operable to receive a graphical diagram, associate each of a plurality of elements in the graphical diagram with one or more predetermined meta-types, identify a plurality of types in the graphical diagram, and determine a category for each of elements in said graphical diagram. A rules execution module is operable to execute containment relationship identification rules to identify one or more containers in the graphical diagram, execute multiplicity identification rules to identify multiplicity relationships in the graphical diagram, and execute advanced semantic rules to identify visual elements that represent attributes and refine relationships between the plurality of types to identify unique behavior.

A program storage device readable by a machine, tangibly embodying a program of instructions executable by the machine to perform a method of identifying graphical model semantics may be also provided.

Further features as well as the structure and operation of various embodiments are described in detail below with reference to the accompanying drawings. In the drawings, like reference numbers indicate identical or functionally similar elements.

### BRIEF DESCRIPTION OF THE DRAWINGS

FIG. 1 illustrates an initial setting stage of a method for identifying graphical model semantics in one embodiment of the present disclosure.

FIG. 2 illustrates a method for identifying graphical model semantics in one embodiment of the present disclosure.

FIG. 3 illustrates an example of a business diagram illustrating a model instance.

FIG. 4 illustrates an example of a business diagram illustrating a model instance.

FIG. 5, FIG. 6, FIG. 7, FIG. 8 and FIG. 9 provide pictorial illustrations of trees constructed in the compact representation method of the present disclosure in identifying graphical model semantics.

### DETAILED DESCRIPTION

A method and system of the present disclosure in one embodiment comprise the following two stages for deducing model types, relationships between the model types and other model behavioral aspects:
1. The initial setting: Given a business diagram (i.e., model), formalize the diagram structure (building blocks) in a way that is most convenient to the user and closest to their intentions.
2. The semantic representation: Given a business diagram, describe all the constraints that are induced by the diagram in a compact manner.

For the initial setting we describe herein two different methods that apply a set of rules. Rules are logical conditions that are based on criteria which people use to identify the diagram building blocks (“element types”). Examples for criteria for type identification may be: the Shape of an element, the Color of an element, the Stereotype of an element, Repetitive Text that appears on different elements, or any combination of these. In the application herein two methods are demonstrated for the initial setting; A Probabilistic Method and a Compact Representation Method. Other methods may be used for the initial setting and the present disclosure does not limit the methodology to the two.

In the present disclosure, the following terminologies are used:

Metadata: Data that represents models. For example, a Unified Modeling Language (UML) model; a Common Object Requesting Broker Architecture (CORBA) object model expressed in Interface Definition Language (IDL); and a relational database schema expressed using Common Warehouse Metamodel (CWM™).

Metamodel: A special kind of model that specifies the abstract syntax of a modeling language; an abstract language for a kind of metadata.

Model: A model represents a concrete or abstract thing of interest, with a specific purpose in mind. The model is related to the thing by an explicit or implicit isomorphism. Models are instances of metamodels and therefore include model elements and links between them. Hereafter, we use “model” and “model instance” interchangeable. We also refer to the semantically enriched business diagrams that serve as input to our algorithm as model instances. These business diagrams are usually being used by practitioners like Business Analysts and Business Architects to illustrate a business issue at hand.

Element (A Model Element): An object in the input model instance.

Link: A connector or association in the input model instance.

Type: With respect to the Object Management Group (OMG) MetaObject Facility (MOF) definitions of “Model” and “MM” above, a type (an element type) is a building block of the meta model (“MM”). For example, if the MM is illustrated in UML class diagram, a type in the metamodel is a “class” of model elements. Consequently, in UML modeling, an Actor is a type in a use case (“UC”) diagram. Another example is: in a Business Process Management Notation (BPMN model), a “task” and a “collapsed processes” are types in the metamodel, in the model instance itself there may appear many different tasks and collapsed processes.

Rule: A logical condition that is applied on a model instance to determine an aspect which will help in the MM creation; rules may include those that identify the types, and others that identify multiplicity relationships between types and other aspects of the MM.

Two methods for the initial setting are described below:
1. A probabilistic method
2. A compact representation method

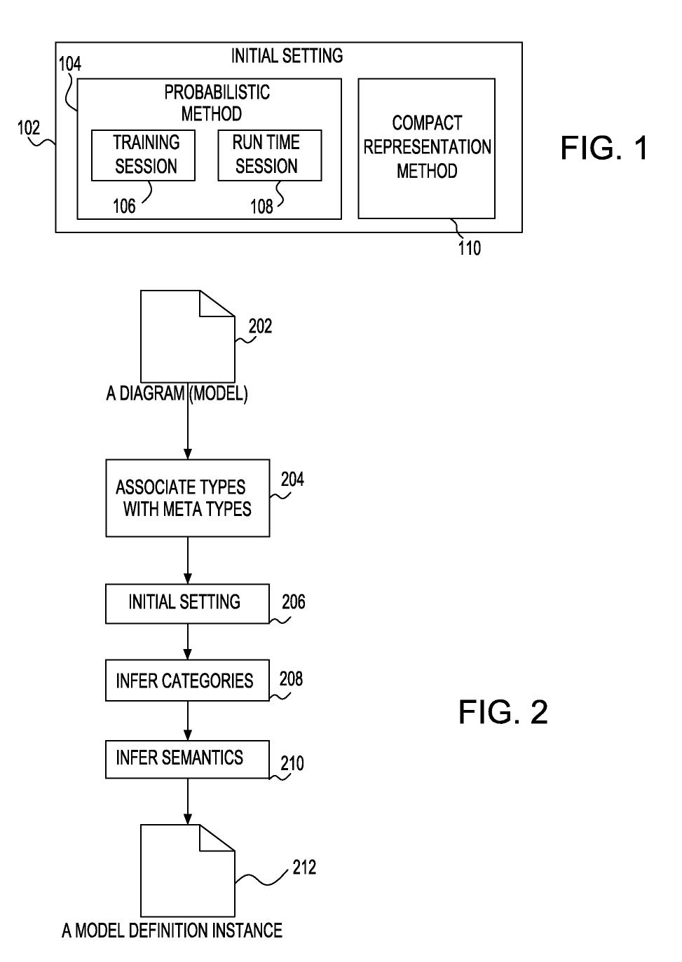

FIG. 1 illustrates the initial setting stage (102) for identifying the building blocks of a business diagram (i.e. model). The two methods that are encapsulated in the initial setting stage (102) are interchangeable and can be changed from users that use it. The probabilistic method (104) comprises two phases: a training phase (106) and a runtime phase (108). Alternatively, the user can use the compact representation method (110) for the same purpose. Initial setting stage, however, is not limited to using only those two methods. Rather, other methods may be employed in the initial setting stage to identify a plurality of types in a model or graphics diagram.

### 1. The Probabilistic Method:

The probabilistic method comprises two phases: a training session phase and a runtime phase. The training session defines measures (probabilities) to be used later on in the runtime phase. These measures are used in the run time phase as predictions to reveal the dominant rule in a given model. Types are determined according to the revealed dominant rule. Therefore, if people tend to identify types first and mostly according to the ‘Shape’ of the element, the result of the training phase will be that “identify types according to shape” will be given a higher probability. Similarly, if people tend to use three criterions in conjunction very rarely, then rules with a combination of three criterions will be given relatively low probability. At runtime, the hypothesis for each rule (namely—is that rule ‘the right’ one for a given model) is tested by using the probabilities outcomes of the training session. The training session can be performed once and then its outcomes used at the runtime for different diagrams.

The following describes determining rules applicability in one embodiment of the present disclosure.

A rule is effective if it serves as a good criterion to identify types in the model instance. A ‘good criterion’ is quantified according to the probability distribution of that rule. The probability distribution describes the values of our measured “event” and probabilities associated with it. The measured event is the number of types each rule found when applied on a given model. Accordingly, for example, when one applies the “identify types according to shape of element” (the “shape rule”), the measured event is the number of different shapes that exists in the model. The probability distribution for the shape rule is obtained by the probability values versus “number of shapes”. Probabilities are computed by using “Bayes Theorem”.

In the training session the probability distribution of an effective rule is expected to be relatively high with relation to certain value (or values) of “number of types”. Accordingly, for an ineffective rule there is no significant “number of types” which is discovered when applied on a diagram (a model instance). For example, a uniform distribution indicates an ineffective rule (no significant number of types) while Gaussian distribution indicates an effective rule. Thus, the rule effectiveness is affected by the distribution Mean and Variance.

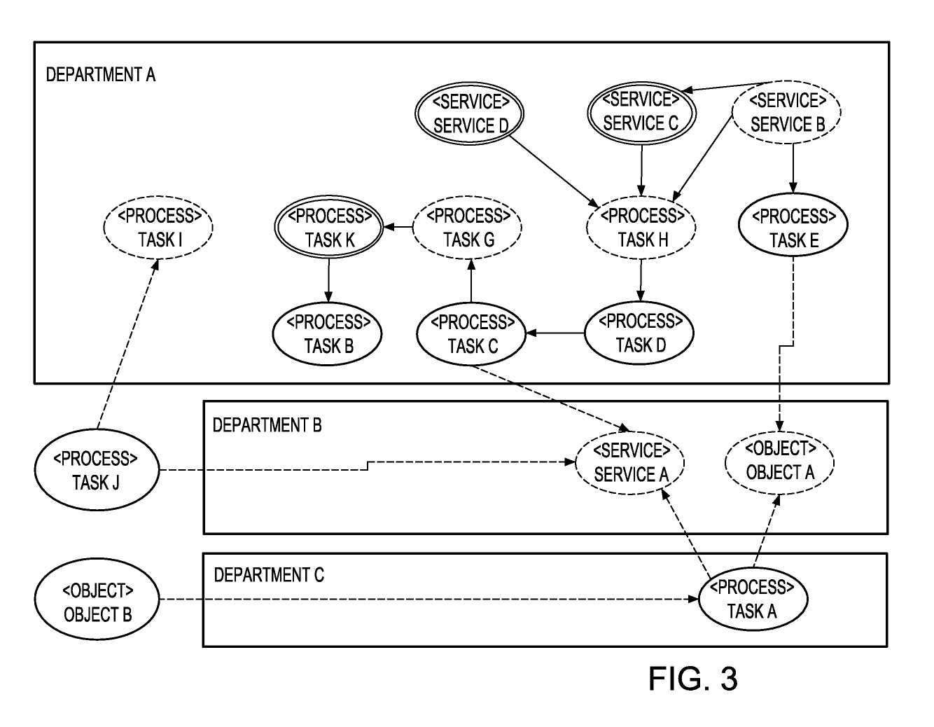

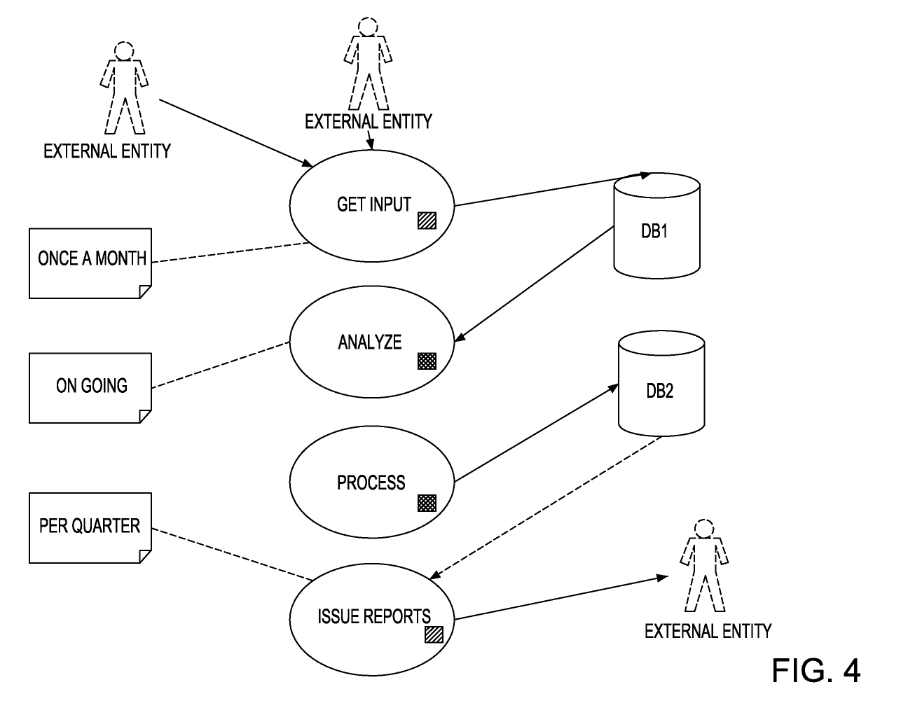

In one embodiment, to decide which rules are effective and how effective they are, i.e., the degree of their effectiveness, a “training session” may be conducted. The input to the training session in one embodiment may be:
1. A large set of instances (models) where each instance (model) is of different MM.
2. For each model the types themselves as expressed by its MM as well as the criteria set that returns them. The training session population has a known “Ground Truth” (i.e. known MMs), thus each of the said models is being related to its MM. As defined above a type is a building block of that MM, therefore the measured “number of types” as well as the types themselves and the right set of criteria (i.e., rule) for each sample in the training session can be computed with relation to this “Ground Truth”. FIG. 3 and FIG. 4 show an example of two different business models. The building blocks of the MM of the model in FIG. 3 are based on the stereotype criterion; therefore, the input Ground Truth of this model to the training session is the four types—Process, Object, Service, and Null—and the Stereotype criterion that returns them. When the rule “identify types according to stereotype” is being executed elements with no stereotype get a null value, like in the case of the diagonal filled rectangles in the example model. The model in FIG. 4 has five types—Person, Cylinder, Note, Ellipse and a Rectangle. The criterion that reveals these types is Shape.
3. A set of rules to be checked. A rule set is a flat (none prioritized) set of rules. Since these rules are meant to derive the building blocks of graphical models, the criteria they encompass may relate to any visual cue in these models. Rules and criteria are entered to the training session phase (which is one of the system modules) as input by the user. Rules in the ‘initial setting’ step include instructions for identifying a type or attribute of a model. For instance, a rule may indicate to identify a component in the model by its color, shape, any other visual cues, or combinations thereof. Suggested rules may include: Identify elements according to shape; Identify elements according to color; Identify elements according to stereotype; Identify elements according to repeated text/labels/letters.

The result of the training session may be the collection of prior probabilities, conditional probabilities and unconditional probabilities to be used in the Run Time session, for example, as terms in the “Bayes Formula”.
1. The prior probability of each rule is computed according to the relative number of samples (i.e., models in the training session), that belong to it. We relate a sample to a rule when the rule returns this sample's Ground Truth. For example, if the “shape” criterion was found to be correct (i.e. found the “Ground Truth”) for half of the population of the training session, then the prior probability of the shape rule would be 0.5.
2. The conditional probability of each rule is the probability to get a specific value for the “number of types” indicator. For example, for the “Shape” rule the training session may output: First, the probability for a range of values for “number of shapes” in a diagram given that “Shape” was the right rule (conditional probability), second, the probability to get a range of values for “number of shapes” in a diagram (unconditional probability).

The Training Session:
1. In one embodiment, the first phase of the training session is running the entire rule set received as input, to record the number of types (# types) identified in each model with relation to each rule. For each model only the number of types of the “right rule” was received as input. The rest of the rules' results (i.e., number of types) per model are being calculated in this phase.
2. Next, we determine each rule's probability distribution according to Bayse Theorm as follows:
   Let m be the number of types a rule found, and let Rule be a certain rule (e.g., “identify types according to shape” or “identify types according to stereotype”) then the probability distribution of Rule is computed as follows:

$$P ( Rule \vert m ) = \frac{P ( m ⋂ Rule )}{P ( m )} = \frac{P ( Rule ) \cdot P ( m \vert Rule )}{P ( m )} \qquad Formula 1$$

Where:
P(Rule|m) denotes the probability that Rule is the “night” rule given that Rule found m types (Rule may have the values; Shape, Color, Stereotype etc.);
P(Rule) denotes the prior probability of the rule (obtained from training session using the “Ground Truth” as explained above);
P(m|Rule) denotes the probability that Rule found m types while Rule is the “right” one.
P(m) denotes the probability that Rule found m types.

For example, for the Rule “identify types according to shape” and number of shapes (3) our training session module will compute:

$$P ( Shape \vert m = 3 ) = \frac{P ( m = 3 ⋂ Shape )}{P ( m = 3 )} = \frac{P ( Shape ) \cdot P ( m = 3 \vert Shape )}{P ( m = 3 )}$$

Where:
P(Shape) is the prior probability of the shape rule in the training session population. It is obtained as follows: let N be the sample size and NS the number of samples in which shape was the right rule (considering their ground truth), then

$$P ( Shape ) = \frac{NS}{N}$$

P(m=3|Shape) is obtained as follows: let NS be the number of samples in which shape was the right rule, and XS be the number of samples in which there where three shapes (i.e., shape found three types) and also was the right rule (considering their ground truth), then

$$P ( m = 3 \vert Shape ) = \frac{XS}{NS}$$

P(m=3) is obtained as follows: let X be the number of samples in which there where three shapes (i.e., shape found 3 types) and N the sample size (i.e., number of models in the training session), then

$$P ( m = 3 ) = \frac{X}{N}$$

Following are two extensions to the above method:
1. Despite the fact that in every model at hand only one rule is the right rule, one may also take into account the number of types other rules find when executed on the same model. The reason for such a desire may be an assumption one may have for the existence of dependency between these values. This option imposes a restriction on the probability model that can de dealt with a joint distribution as follows:
Let mᵥ be a vector of values. Each component in vector indicates ‘number of types’ that was obtained by a certain rule over the given model.
Let Rule be a certain rule (e.g., “identify types according to shape” or “identify types according to stereotype”). The probability distribution of Rule is computed as follows:

$$P ( Rule \vert {m}_{v} ) = \frac{P ( {m}_{v} ⋂ Rule )}{P ( {m}_{v} )} = \frac{P ( Rule ) \cdot P ( {m}_{v} \vert Rule )}{P ( {m}_{v} )} \qquad Formula 2$$

Where:
P(Rule|mᵥ) denotes the probability that Rule is the “right” one (Rule may have the values: Shape, Color, Stereotype etc), given mᵥ which is the array of types found all the rules
P(Rule) denotes the prior probability of the rule that is under question (obtained from training session using the “Ground Truth” as explained above);
P(mᵥ|Rule) denotes the probability that the array of values mᵥ was obtained while Rule is the “right” one;
P(mᵥ) denotes the probability to obtain the array mᵥ.

For example, for the Rule “identify types according to shape” and number of shapes 5, number of colors 1, number of stereotypes 1, the training session module will compute:

$$P ( Shape \vert {m}_{v} = ( 5 , 1 , 1 ) ) = \frac{P ( {m}_{v} = ( 5 , 1 , 1 ) ⋂ Shape )}{P ( {m}_{v} = ( 5 , 1 , 1 ) )} = \frac{P ( Shape ) \cdot P ( {m}_{v} = ( 5 , 1 , 1 ) \vert Shape )}{P ( {m}_{v} = ( 5 , 1 , 1 ) )}$$

Where:
P(Shape) is the prior probability of the shape rule in the training session population. It is obtained as follows: let N be the sample size and NS the number of samples in which shape was the right rule (considering their ground truth), then

$$P ( Shape ) = \frac{NS}{N}$$

P(mᵥ=(5,1,1)|Shape) is obtained as follows: let NS be the number of samples in which shape was the right rule, and XS be the number of samples in which there where 5 shapes (i.e. shape found 5 types), 1 (or none) colors and 1 (or none) stereotypes and also shape was the right rule (considering their ground truth), then

$$P ( {m}_{v} = ( 5 , 1 , 1 ) \vert Shape ) = \frac{XS}{NS}$$

P(mᵥ=(5,1,1)) is obtained as follows: let X be the number of samples in which there where 5 shapes (i.e. shape found 5 types), 1 (or none) colors and 1 (or none) stereotypes, and let N be the sample size (i.e. number of models in the training session), then

$$P ( {m}_{v} = ( 5 , 1 , 1 ) = \frac{X}{N}$$

2. The following formula is the second extension to the method. It may be applied as a relaxation of the former restriction. In the formula provided below one may assume independency between the number of types that the different rules found given that one rule is right. Despite the independency said, these terms are not omitted from the formula as in the original one (Formula 1). It is worth noting that the difference between the following formula (Formula 3) and the original formula (Formula 1) is that the latter formula's significant terms are: the probability to receive a certain number of types in a model given that one Rule is right and the prior probability of that Rule. Whereas in the following formula (Formula 3), given that one Rule is right, still the probability to receive values for number of types by the other rules is not considered negligible. Therefore the probability distribution of Rule is computed as follows:

$$P ( Rule \vert {m}_{v} ) = \frac{P ( Rule ) \cdot {\prod }_{rule} P ( {m}_{rule} \vert Rule )}{{\sum }_{{rule}_{1}} P ( {rule}_{1} ) \cdot {\prod }_{{rule}_{2}}^{ } P ( {m}_{{rule}_{2}} \vert {rule}_{1} )} \qquad Formula 3$$

Where:
P(Rule|mᵥ) denotes the probability that Rule is the “right” one (Rule may have the values: Shape, Color, Stereotype etc), given mᵥ which is the array of types found by all the rules
P(Rule) denotes the prior probability of the rule that is under question (obtained from training session using the “Ground Truth” as explained above);
P(mᵣᵤₗₑ|Rule) denotes the probability that the component mₘᵤₗₑ in the array of values mᵥ was obtained while Rule is the “right” one (the component mᵣᵤₗₑ denotes the number of types that rule found, rule may have the values: shape, color, stereotype etc.);
P(rule₁) denotes the prior probability of rule₁;
P(mᵣᵤₗₑ_{₂}|rule₁) denotes the probability that the component mₘᵤₗₑ_{₂} in the array of values mᵥ was obtained while rule₁ is the “right” one (the component mᵣᵤₗₑ_{₂} denotes the number of types that rule₂ found, rule₂ may have the values: shape, color, stereotype etc).

For example, for the Rule “identify types according to shape” and number of shapes 5, number of colors 1, number of stereotypes 1, the training session module will compute:

$$P ( Shape \vert {m}_{v} = ( 5 , 1 , 1 ) ) = \frac{\begin{matrix}P ( Shape ) \cdot P ( {m}_{shape} = 5 \vert Shape ) \cdot \\ P ( {m}_{color} = 1 \vert Shape ) \cdot P ( {m}_{stereotype} = 1 \vert Shape )\end{matrix}}{Part 1 + Part 2 + Part 3}$$

$$Part 1 = P ( Shape ) \cdot ( P ( {m}_{shape} = 5 \vert Shape ) \cdot P ( {m}_{color} = 1 \vert Shape ) \cdot P ( {m}_{stereotype} = 1 \vert Shape ) )$$

$$Part 2 = P ( Color ) \cdot ( P ( {m}_{shape} = 5 \vert Color ) \cdot P ( {m}_{color} = 1 \vert Color ) \cdot P ( {m}_{stereotype} = 1 \vert Color ) )$$

$$Part 3 = P ( Stereotype ) \cdot ( P ( {m}_{shape} = 5 \vert Stereotype ) \cdot P ( {m}_{color} = 1 \vert Stereotype ) \cdot P ( {m}_{stereotype} = 1 \vert Stereotype ) )$$

Where:
P(Shape) is the prior probability of the shape rule in the training session population.
   It is obtained as follows: let N be the sample size and NS the number of samples in which shape was the right rule (considering their ground truth), then

$$P ( Shape ) = \frac{NS}{N}$$

P(Color) is the prior probability of the color rule in the training session population. It is obtained as follows: let N be the sample size and NC the number of samples in which color was the right rule (considering their ground truth), then

$$P ( Color ) = \frac{NC}{N}$$

P(Stereotype) is the prior probability of the stereotype rule in the training session population. It is obtained as follows: let N be the sample size and NST the number of samples in which stereotype was the right rule (considering their ground truth), then

$$P ( Stereotype ) = \frac{NST}{N}$$

P(mₛₕₐₚₑ=5|Shape) is obtained as follows: let NS be the number of samples in which shape was the right rule, and XS be the number of samples in which there where 5 shapes (i.e., shape found 5 types) and also shape was the right rule (considering their ground truth), then

$$P ( {m}_{shape} = 5 \vert Shape ) = \frac{XS}{NS}$$

P(m_{color}=1|Shape) is obtained as follows: let NS be the number of samples in which shape was the right rule, and XC be the number of samples in which there where 1 (or none) colors (i.e., color found 1 type) and also shape was the right rule (considering their ground truth), then

$$P ( {m}_{color} = 1 \vert Shape ) = \frac{XC}{NS}$$

P(m_{stereotype}=1|Shape) is obtained as follows: let NS be the number of samples in which shape was the right rule, and XST be the number of samples in which there where 1 (or none) stereptypes (i.e., stereotype found 1 type) and also shape was the right rule (considering their ground truth), then

$$P ( {m}_{stereotype} = 1 \vert Shape ) = \frac{XST}{NS}$$

P(mₛₕₐₚₑ=5|Color) is obtained as follows: let NC be the number of samples in which color was the right rule, and YS be the number of samples in which there where 5 shapes (i.e., shape found 5 types) and also color was the right rule (considering their ground truth), then

$$P ( {m}_{shape} = 5 \vert Color ) = \frac{YS}{NC}$$

P(m_{color}=1|Color) is obtained as follows: let NC be the number of samples in which color was the right rule, and YC be the number of samples in which there where 1 (or none) colors (i.e., color found 1 type) and also color was the right rule (considering their ground truth), then

$$P ( {m}_{color} = 1 \vert Color ) = \frac{YC}{NC}$$

P(m_{stereotype}=1|Color) is obtained as follows: let NC be the number of samples in which color was the right rule, and YST be the number of samples in which there where 1 (or none) stereotype (i.e., stereotype found 1 type) and also color was the right rule (considering their ground truth), then

$$P ( {m}_{stereotype} = 1 \vert Color ) = \frac{YST}{NC}$$

P(mₛₕₐₚₑ=5 Stereotype) is obtained as follows: let NST be the number of samples in which stereotype was the right rule, and ZS be the number of samples in which there where 5 shapes (i.e., shape found 5 types) and also stereotype was the right rule (considering their ground truth), then

$$P ( {m}_{shape} = 5 \vert Stereotype ) = \frac{ZS}{NST}$$

P(m_{color}=1|Stereotype) is obtained as follows: let NST be the number of samples in which stereotype was the right rule, and ZC be the number of samples in which there was 1 (or none) color (i.e., color found 1 type) and also stereotype was the right rule (considering their ground truth), then

$$P ( {m}_{color} = 1 \vert Stereotype ) = \frac{ZC}{NST}$$

P(m_{stereotype}=1|Stereotype) is obtained as follows: let NST be the number of samples in which stereotype was the right rule, and ZST be the number of samples in which there was 1 (or none) stereotype (i.e., stereotype found 1 type) and also stereotype was the right rule (considering their ground truth), then

$$P ( {m}_{stereotype} = 1 \vert Stereotype ) = \frac{ZST}{NST}$$

### Run Time Session

Input to the run time session may be:
1. A model, i.e., a graphical diagram comprising elements.
2. For each element, its associated meta-type is given (e.g., for the “extended graph” family of models, where underlying structure is of graph and containers, this set may be: {link, element, container}).
3. The results of the training session in the format of a mapping of each inspected rule to its probabilities as follows:
   For each Rule its prior probability P(Rule).
   For each Rule and for each value of m (m is a natural number that represents the number of types that rule found on one or more diagrams in the training session) P(Rule|m).

Optional input may include:
For each Rule and for each value of mᵥ (mᵥ is an array of natural numbers each representing the number of types that each of the inspected rules found on one or more diagrams in the training session)
P(Rule|mᵥ)
This measure can be computed in two different ways, as explained above, depending on the desired extension the user chooses to the method.

The results of the run time session may be:
1. A set of types that make up the diagram structure.
2. A Rule (e.g., composed of set of in conjunction criteria) according to which the above types were determined.
3. A set of attributes that are reflected by the criteria that were not selected. For example, if the “Shape” criterion was selected to indicate types, and “Color” and “Stereotype” also appear in the diagram, then they indicate attributes of the different shapes of that diagram.

The run time session procedure may be:
1. Choose a method (original or one of the extensions as in Formula 1, Formula 2 or Formula 3).
2. Run the set of rules that relate to identifying types and collect results according to method (m or mᵥ).
3. For each inspected Rule lookup the match probabilities value in the training session results, according to method: P(Rule|m) or P(Rule|mᵥ).
4. Choose the leading Rule according to which types of the given diagram will be determined as follows:
   a. Sort probabilities in descending order.
   b. Select the higher probability and output its relating Rule, indicator (m or mᵥ) and set of identified types.
   c. As a refinement to the above decision method use the following condition:

if the difference between values of the top most probability and the second best probability is higher than a predefined threshold, select the top most probability, and output its relating Rule, indicator (m or mᵥ) and set of identified types. Else choose a different method for the initial setting (e.g., the compact representation method detailed below).
Steps b. and c. above may farther include the following principle:
Prefer most inclusive rule when more than one rule identifies the same set of types.
   For Example: Consider the following example that describes three Rules:
   “Identify type according to shape” b. “Identify type according to color” c. “Identify type according to shape and color in conjunction.” Now suppose that the user in their model instance gave each type both a shape and a distinguished color (e.g., “a green circle”, “a red rectangle” and a “yellow triangular”). Then rule “a” would identify the types accurately (a circle, a rectangle and a triangular), however, also rules “b” (a green unit, a red unit, a triangular unit) and “c” (a green circle, a red rectangle and a yellow triangular) would do so. However, we would need to use rule “c”, if we want that eventually, when a user draws another instance of the same model, they will be presented with a “green circle” on palette, and not just a “circle”.

Following is an example of the run time session procedure:

Consider the diagram on FIG. 3, and relate to the following annotations: the “Shape” of elements, the “Stereotype” of elements as appeared by the text in triangular brackets and the “Effect” of elements as appeared by any fill effects or contour lines. We bundled the fill affect and contour line of each element, relate to them as one visual cue and call it “Effect” mainly for the sake of simplicity of herein explanation. It is worth noting that one could further distinguish between elements' contours and elements' fill effects and thus relate to them with different rules.
1. Suppose we chose the original method without extensions to identify its building blocks.
2. Suppose the inspected rules are:
   “Identify types according to shape” (“Shape”), “Identify types according to effect” (“Effect”), and “Identify types according to Stereotype” (“Stereotype”). Effect may include different colors. Result may be:

| Rule | m |
|---|---|
| Shape | 2 |
| Effect | 5 |
| Stereotype | 4 |

3. Suppose the probabilities value from the training session are;

| Probability | Value |
|---|---|
| P (Shape\|m = 2) | 0.53 |
| P (Effect\|m = 5) | 0.4 |
| P (Stereotype\|m = 4) | 0.8 |

Select the higher probability from the ordered list of probabilities: P(Stereotype|m=4), therefore types are being determined according to stereotypes, namely “Process”, “Object”, “Service”, “Null”.

Another method for the initial setting is described below:

2. The compact representation method
The compact representation method is based on “Graph Theory”. This method can find the best way for the user to draw a model instance (and derive diagram building blocks accordingly). The method tries to minimize the number of operations the user needs in order to draw an element. For instance, if a diagram building block which is stereotyped “Process” appears on the model instance only with the notation of a blue ellipse, than the tool will realize this, thus put a blue ellipse process on palette ready for the user to drag and drop to canvas whenever drawing a new model instance, that is, the user will not need to specify the color or shape when the user works with process elements.

The input to the compact representation method may be:
1. A model, i.e., a graphical diagram comprising elements.
2. One or more criteria which may relate to any visual cue in graphical models. For instance, a criterion in the criteria set may indicate the identification of a component in the model by its color, shape, or any other visual cues. Unlike the ‘probabilistic method’, in the ‘compact representation method’ the input comprises a set of Criteria, not set of Rules. The distinction between Rules and Criteria is that Rules may contain more than one criterion in conjunction.

The result of the compact representation method may be:

1. A set of types that make up the diagram structure.

2. For each type the combination of criteria that relate to it.

The procedure of the compact representation method is as follows:

The algorithm performs four consecutive steps:
First it builds a collection of trees each corresponds to a specific order of criteria.
Second the algorithm applies a shrinking technique that reduces trees average height.
Third the algorithm reduces the number of suggested trees by using business rules.
Fourth the algorithm applies a method (hereafter two optional ones are suggested) to pick the best tree and output its top level nodes that correspond to the MM types.
   Building the collection of trees

Let II be the input model instance in the form of a collection of nodes.

For each permutation of criteria p compose an array Ap that each of its entries reflects a criterion. For example if the set of criteria is {Shape, Color, Stereotype}, compose 6 (3!) arrays.

For each array of permutations Ap construct an associated tree Tp. Each level l in Tp is associated with an entry in Ap and each node u at l is associated with a possible value of Ap's entry such that a path from the root r to u corresponds to an existing combination of criteria values in II.

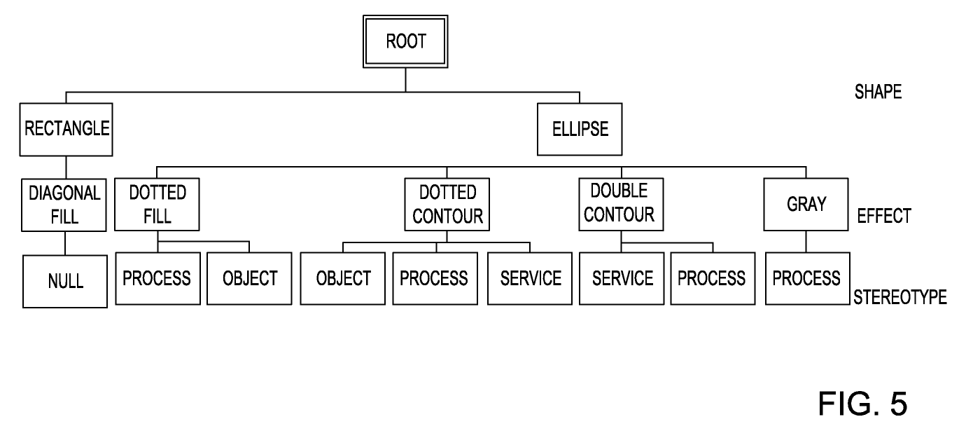

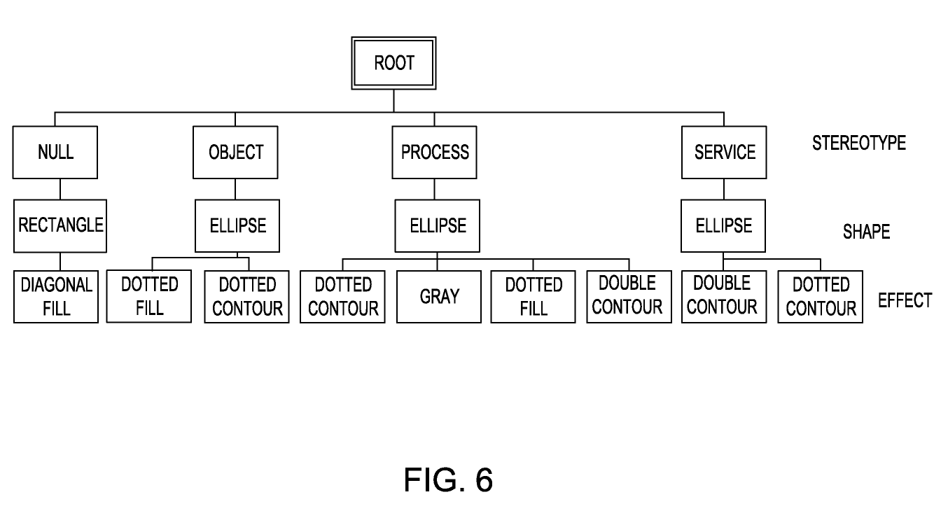

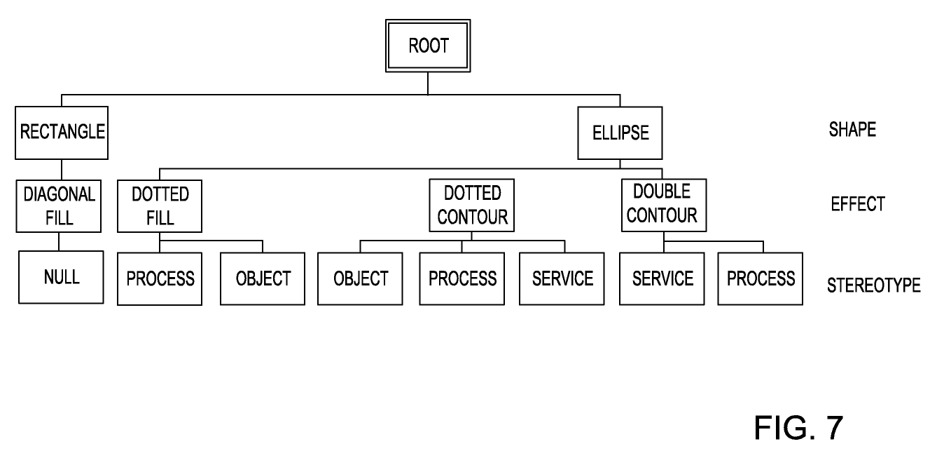

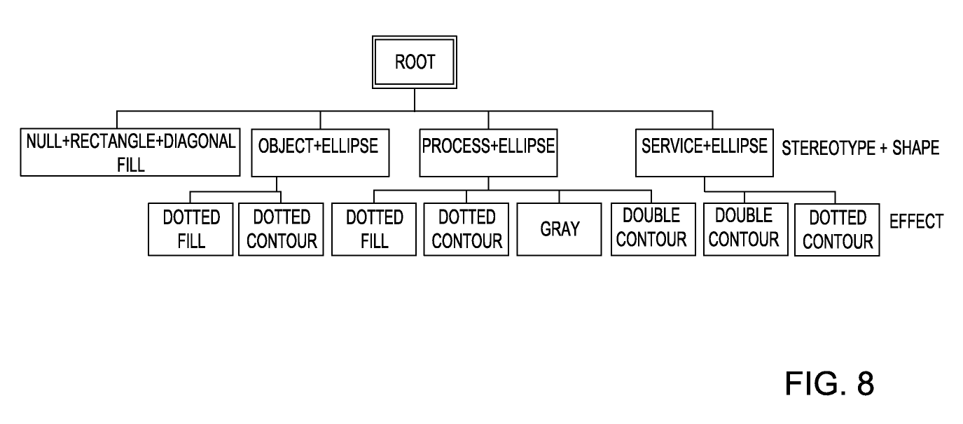

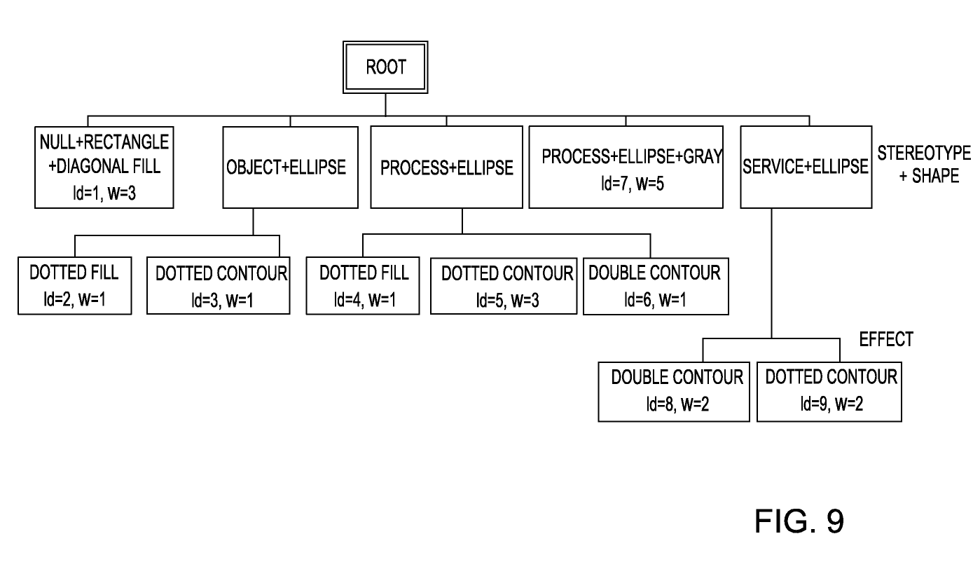

FIG. 5 and FIG. 6 provide a pictorial illustration of two of the trees that the algorithm constructs for the model on FIG. 3. As before for the sake of simplicity we'll bundle the fill affect and contour line of each element of FIG. 3, relate to them as one visual cue and call it “Effect”. It is worth noting that one could further distinguish between elements' contours and elements' fill effects and thus relate to them with different criteria.

The tree on FIG. 5 corresponds to the permutation (Shape, Effect, Stereotype), while the tree on FIG. 6 corresponds to the permutation (Stereotype, Shape, Effect). Consider the tree on FIG. 5. the third level of this tree is Stereotype. Each node at this level is associated with a possible value of the entry “Stereotype” in the permutation. Also observe the path (Root, Ellipse, Double Contour, Service) that goes from the root to one of the leaves. This path corresponds to the combination of features of two of the elements in the diagram of FIG. 3.

The construction of Tp may be done as follows:

The algorithm starts by constructing the root r of Tp (the root is the only node in Tp with no relation to Ap's entries). The algorithm traverses over the collection of elements II, picks one element and then expands the tree iteratively according to levels. Let vₗ be the value of a criterion of some element e in II (this criterion corresponds to the current level of Tp that the algorithm now expands). The algorithm builds a node u in rp corresponds to vₗ, after searching all sub-trees in Tp and locating the sub-tree that its combination of criteria values equals to these of e. The node u will be added to Tp in that sub-tree as a child to the leaf in the path that represent the above mentioned combination, only if such leaf do not exist yet in Tp.

For example, consider the tree on FIG. 7. This tree is only partial. It does not contain nodes of the diagram of FIG. 3 that correspond to elements that have the features: “Process”, “Gray”, “Ellipse”. This tree may serve as an example for a tree under construction of the algorithm. Consider “Task C” on FIG. 3, and suppose the algorithm now picked it from the collection of elements of the diagram of FIG. 3 and need to construct the nodes that correspond to it. The first criterion to examine is “Shape” and the value of the “Shape” of Task 3 is “Ellipse”, therefore, the algorithm checks whether “Ellipse” exists in the tree, and since it does it moves to the second criterion, which is “Effect. The value of the “Effect” of Task C is “Gray”, therefore, the algorithm goes to the “Ellipse” sub-tree and since there is no child with the value of “Gray” it adds the node “Gray” to the parent “Ellipse”. The algorithm checks the third criterion which is “Stereotype”. Again the Ellipse sub-tree is picked and then the “Gray” sub-tree. Finally the node “Process” is being added as a child of the “Gray” node.

Reducing trees' height (“shrinking technique”)

The leaves of each tree represent all combinations of elements' features in the model. Therefore, the path length from root to leaf serves as an indicator for the amount of work the user has to do (when acting in a drawing tool) until they reach their desired notation. The shrinking operation is done in order to collapse branches that correspond to sequence of operations that can be reduced. Shrinking can be done both forward and backwards.

Forward shrinking may be done according to the following method:

Examine levels of tree iteratively, starting from the root. At each level search for nodes that have only one child, then join parent and child to create a node that corresponds to the combined criteria.

For example, consider the tree of FIG. 6. Applying forward shrinking on this tree will result in the conjunction of Stereotype and Shape for the nodes: “Object+Ellipse”, “Process+Ellipse”, “Service+Ellipse”, and the conjunction of Stereotype and Shape and Effect for the node: “Null+Rectangle+Diagonal Fill”. The resulting tree is provided in FIG. 8

Backwards shrinking may be done according to the following method:

Examine levels of tree iteratively, starting from the leaf level. At each level search for nodes that have children that are unique to them (i.e., other nodes at their level do not have a child that is equal to the one being examined). Then join parent and child to create a node that corresponds to the combined criteria.

For example, consider FIG. 8. Performing backwards shrinking on this tree will locate the “Gray” node as a unique child of “Process+Ellipse” node, thus result in the conjunction of the “Gray” node and its parent the “Process+Ellipse” node. The resulting tree appears in FIG. 9.

For each tree the algorithm performs forward shrinking, then backwards shrinking and then forward shrinking again.

Reducing the number of suggested trees by using business rules

To reduce the number of candidate trees before selecting the best tree, eliminate trees according to overriding rules. Overriding rule may be as follows:
If the first level has more than 10 types omit the tree.
If stereotype is one of the criteria—always put it at the top level (it is the strongest).
If the only color in diagram is white then, do not use color as part of type identification.

Selecting the best tree

Each of the collection of trees from the previous step corresponds to a possible set of types of the MM. The selection of the best tree may be done according to two example approaches: the height approach and the frequent approach.

In the height approach the algorithm selects the tree that has the minimum height. That tree represents the set of types that minimize the number of operations a user has to do to get to a full featured element in a diagram instance.

Following is the height method. Let d be the length of some path (length is measured according to number of edges) from the tree root to a leaf. Then the algorithm selects the tree which adheres to:

$$min ( {\sum }_{paths} d )$$

In the frequent approach the algorithm selects the tree that has the minimum weight. That tree represents the set of types that minimize the number of operations a user has to do to get to the most frequent full featured elements in the diagram instance.

Following is the weight method. Let d be the length of some path from the tree root to a leaf, and let n be the number of elements from the input instance that suit the criteria values combination that this path represents. Then the algorithm selects the tree which adheres to:

$$min ( {\sum }_{paths} d \cdot n$$

Following is an example for weights determination: Consider the diagram on FIG. 3. FIG. 9 illustrates one of its corresponding trees. We enumerated each leaf with an identifying or identifier (id) number and then computed its weight. The ids were given for the sake of simplicity rather than using leaves' names. Consider leaf id 5, that represent the “dotted contour” ellipse process. In order to calculate its weight we counted the number of “dotted contour” ellipse processes that exist in the diagram of FIG. 3. Since there are 3 such elements the weight of leaf 5 is 3. We continue in the same way for all the leaves of FIG. 9. The weight of the tree is computed according to the following values:

| Leaf id | Branch Length | Weight |
|---|---|---|
| 1 | 1 | 3 |
| 2 | 2 | 1 |
| 3 | 2 | 1 |
| 4 | 2 | 1 |
| 5 | 2 | 3 |
| 6 | 2 | 1 |
| 7 | 1 | 5 |
| 8 | 2 | 2 |
| 9 | 2 | 2 |

And the tree weight is therefore: 1*3+2*1+2*1+2*1+2*3+2*1+1*5+2*2+2*2=30.

The set of types the algorithm outputs corresponds to the nodes at the first level of the selected tree. Therefore, if the tree of FIG. 9 is selected then the set of types the algorithm will output will be: a Diagonal Fill Rectangle, an Ellipse with the stereotype “Object”, an Ellipse with the stereotype “Process”, a Gray Ellipse with the stereotype “Process” and an Ellipse with the stereotype “Service”. Observe that both an un-colored Process Ellipse and a Gray Process Ellipse will be outputted since whenever a Gray Ellipse is being used it is a “Process” but not vise versa.

The following describes deducing model types and semantics of a given diagram in one embodiment of the present disclosure. FIG. 2 illustrates the algorithm in one embodiment of the present disclosure. Input to the algorithm may include:
A model, i.e., a diagram of elements.
For each element its associated meta-type is given (an example for meta-types set may be: {link, element, container}). There is a difference between meta-types that are not identified by this algorithm, and types (which are meta-elements) which the training session goal is to infer them.

At 202, a diagram (model) is being consumed by the algorithm. At 204, associate type with meta-type (e.g., node, link, container). At 206, run initial setting stage to identify types. At 208 find element's category. At 210 infer semantics. At 212 output a model definition instance (i.e., the required MM).

Step 204 (associate type with meta-type) refers to meta-types that may be provided as an input for the algorithm. Some processing should be done on the input in order to achieve this goal. For example if diagrams are provided with underlying XML representation then a parser for that XML representation can extract its meta-types data (this parser may be a separate module of the system, separate from the algorithm herein). Elements may be associated with multiple meta-types. An example may be a type which is both a link and a container.

At initial setting step 206, types are identified. As described above, different methods may be used to identify types. For instance, a probabilistic method or a compact representation method to perform this task. Other methods may be employed. If a probabilistic method is chosen, a training session is run, upon which the types identification of the run time session is determined.

Step 206 may further include the following steps:
1. As a preprocessing step collect elements of diagram into buckets according to their meta-types. For example, if the set of meta-types includes {nodes, links}, divide the set of elements in a given diagram to: nodes subset and links subset. Then perform the initial setting step (206) on each subset to infer types. For example, if the subsets are nodes and links, infer node types and link types using either the probabilistic or the compact representation method.
2. This step is optional. Different set of meta-types belong to different “Model Family”. Models can be classified into Model Families according to shared structural characteristics like the set of meta-types and constrains on the relations between element types. For example, the most frequent family is the “graph” family which is made of nodes and edges (links) meta-types, an example of which is illustrated in FIG. 4. Another family may be the “table” family which is made of nodes and containers meta-types. Consider conducting a “supervised learning” preprocessing step to extract the model family of a given input model. A “supervised learning” is conducted by a limited set of questions that are represented to the user before actually applying the initial setting stage. The user's answers to these preliminary questions may direct the system to infer the “model family” from which the system can derive the applicable set of meta-types.

Step 208 in FIG. 2 refers to finding the type's category. Types may be categorized for orientation purposes while users work with a system after the inferencing part is executed. For example, consider a gallery of types from which the user may select the desired building blocks in order to create a new model. If building blocks are grouped into meaningful “drawers”, their role in the model is better comprehended by users. For example, for a Business Process Modeling Notation (BPMN) model the gallery of types may be divided to the following categories: Activities, Events, Gateways, Flows and Artifacts. Step 208 may further include the following steps for categorization. The inferred categories are considered valid if this categorization induces a partition of the set of types identified. We refer to “partition” as in mathematics, namely, a partition of the set of types is a division of this set into non-overlapping “parts” that cover all the set. More formally, these parts are both collectively exhaustive and mutually exclusive with respect to the set being partitioned.
1. Categorize according to links, when the links induce a partition which is based on the linkage between types. For example, FIG. 3 illustrates a diagram where containers cannot be connected to other elements. Therefore, the partitioning that the linkage between elements induces is: connectable types (Process, Service and Object) and none connectable types (green rectangles).
2. Categorize according to the “identifying types” rules results. A rule will be considered as a “categorizing rule” if:
   a. There is a differentiating gap between the #types that were chosen (in step 206 initial settings) and the #types which this rule found, and
   b. The rule induces a partition of the set of identified types (the types identified in step 206). For example, FIG. 4. illustrates a diagram where “identify types according to shape” is the “Ground Truth” rule. Consider a situation where it was also the rule that was chosen in step 206 (resulting in #type=3, the small rectangles are identified as features rather than types, see discussion hereafter). Now consider the rule “identify types according to effect”. This rule results in # type=2 (part “a” above). Also this rule divides the set of types into two groups that collectively cover all elements in diagram (part “b” above).

In infer semantics step 210, the semantic representation, i.e., constraints that are induced by the diagram, are extracted. While traversing over the diagram, build a matrix that will be composed of the elements from the diagram. For each element summarize all the information about containment, connectivity, etc. Next, search for certain behaviors. For example, is there a certain connector used only when connecting types that belong to different containers?

This step may include the following stages:
1. Run “containment relationship” identification to identify which types are aggregated in a container type.

For each type identified as Container meta-type,
Traverse over all instances of this type,
   Identify Types of elements contained in the instance.

The union of all identified types denotes the types which can be contained in that specific type.
2. Run “multiplicity” identification regarding to relationships (refer to all types) For each relationship:
   Build a matrix which its rows are source elements and its columns are types. The cells contain counters of the number of times an element was connected as a source to an element of a given type.
   Go over all relationship instances and for each source element, check its target element type and increment the appropriate cell counter.
   If a counter is greater than one, then the type of that source element is connected to the type in the matrix with many multiplicity, otherwise the multiplicity is as the counter indicates (0,1).
   Do the same but replace “source” with “target”.
3. Run advanced semantic rules
3.1 Identify visual elements that represent attributes (as opposed to types). When visual element represents an attribute (characteristic of a type), it is usually a non connected element that can be identified as follows:

Use the conjunction of the following cases:
1. The element's shape or its inner text is repeated.
2. The element is part of another element and it appears at the same relative location within all container elements of the model instance.
3. The element does not have any association to other elements.
4. The element's size is considerably smaller than other contained elements.

For example, FIG. 4 illustrates the use of attributes in small rectangle that is contained within the ellipse type. These rectangles indicate a certain feature of the type “ellipse”. It may be found by the algorithm according to: 1) its repeated nature in the model instance (it repeats in all ellipses); 2) its aggregation in these ellipses and the same relative location on ellipse surface; 3) its non-connect ability, i.e., no connector relates to it in model.
3.2 Refine relationships to identify unique behavior. Example for such behavior may be, “Yellow rectangles can be connected only to white rectangles”, “Components of separate containers can be connected only with dashed lines”. The advanced semantic constraints can be searched while traversing over the above mentioned matrix that is composed of all the elements from the diagram each with reference to its metadata (types and attributes) that were inferred at early stages of the algorithm.

Step 212 represents the result of the algorithm. The algorithm outputs a model definition comprising the building blocks of the input model and its semantic representation, i.e., a description of all the constraints that are induced by the diagram in a compact manner.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements, if any, in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

Various aspects of the present disclosure may be embodied as a program, software, or computer instructions embodied in a computer or machine usable or readable medium, which causes the computer or machine to perform the steps of the method when executed on the computer, processor, and/or machine. A program storage device readable by a machine, tangibly embodying a program of instructions executable by the machine to perform various functionalities and methods described in the present disclosure is also provided.

The system and method of the present disclosure may be implemented and run on a general-purpose computer or special-purpose computer system. The computer system may be any type of known or will be known systems and may typically include a processor, memory device, a storage device, input/output devices, internal buses, and/or a communications interface for communicating with other computer systems in conjunction with communication hardware and software, etc.

The terms “computer system” and “computer network” as may be used in the present application may include a variety of combinations of fixed and/or portable computer hardware, software, peripherals, and storage devices. The computer system may include a plurality of individual components that are networked or otherwise linked to perform collaboratively, or may include one or more stand-alone components. The hardware and software components of the computer system of the present application may include and may be included within fixed and portable devices such as desktop, laptop, server. A module may be a component of a device, software, program or system that implements some “functionality”, which can be embodied as software, hardware, firmware, electronic circuitry, or etc.

The embodiments described above are illustrative examples and it should not be construed that the present invention is limited to these particular embodiments. Thus, various changes and modifications may be effected by one skilled in the art without departing from the spirit or scope of the invention as defined in the appended claims.

We claim:

1. A computer-implemented method for identifying graphical model semantics, comprising:
receiving a graphical diagram;
associating each of a plurality of elements from the diagram with one or more predetermined meta-types;
identifying a plurality of types in the graphical diagram;
determining a category for each of elements in said graphical diagram;
executing containment relationship identification rules to identify one or more containers in the graphical diagram;
executing multiplicity identification rules to identify multiplicity relationships in the graphical diagram; and
executing advanced semantic rules to identify visual elements that represent attributes and refine relationships between the plurality of types to identify unique behavior.

2. The method of claim 1, wherein said predetermined meta-types describes one or more structures of model family associated with the plurality of elements.

3. The method of claim 1, wherein the step of executing multiplicity identification rules includes executing multiplicity identification rules for one or more of said plurality of types associated with a link meta-type.

4. The method of claim 1, wherein the graphical diagram includes a business model representing a business entity, a business issue, a business problem, a business process, a business strategy, or combinations thereof.

5. The method of claim 1, wherein the step of identifying a plurality of types includes using a probabilistic method.

6. The method of claim 5, wherein the probabilistic method includes a training phase and a runtime phase.

7. The method of claim 1, wherein the step of identifying a plurality of types includes using a compact representation method.

8. The method of claim 7, wherein the compact representation method is based on graph theory.

9. The method of claim 1, wherein the step of identifying a plurality of types includes using a probabilistic method, the probabilistic method including at least selecting one rule for type identification, said one rule being most inclusive rule when more than one rule identifies same set of types.

10. The method of claim 1, wherein said step of identifying a plurality of types includes:
choosing a probability model describing a type of probability distribution;
running a set of rules that identify types and collecting results from running the set of rules;
for each rule run in the running step, looking-up match probabilities value according to the probability model;
extracting a leading rule from said set of rules having highest matched probabilities value; and
executing the leading rule on the graphical diagram to obtain meta-model types.

11. The method of claim 1, wherein said step of identifying a plurality of types includes:
building a collection of trees, each tree corresponding to a specific order of criteria;
reducing average height of the trees;
reducing number of trees in the collection of trees by using one or more business rules;
selecting a candidate tree from said reduced collection of trees using a predetermined method; and outputting one or more top level nodes of the candidate tree, the top level nodes corresponding to meta-model types.

12. The method of claim 11, wherein the step of selecting a candidate tree includes selecting a tree with minimum height.

13. The method of claim 11, wherein the step of selecting a candidate tree includes selecting a tree with minimum weight, wherein weights are determined according to number of elements from the graphical diagram that meet a predetermined criterion.

14. The method of claim 1, wherein the step of determining a category includes:
categorizing according to link types.

15. The method of claim 1, wherein the step of determining a category includes:
categorizing according to identified types.

16. The method of claim 1, further including:
performing a semantic representation stage to select said containment relationships, said multiplicity identification, and said advanced semantic rules.

17. A system for identifying graphical model semantics, comprising:
a processor:
a module operable to receive a graphical diagram, assign each of a plurality of elements in the graphical diagram with one or more predetermined meta-types, identify a plurality of types in the graphical diagram, and determine a category for each of elements in said graphical diagram; and
a rules execution module operable to identify one or more containment relationships in the graphical diagram, identify multiplicity relationships in the graphical diagram, and execute advanced semantic rules to identify visual elements that represent attributes and refine relationships between the plurality of types to identify unique behavior.

18. The system of claim 17, wherein said predetermined meta-types depend on model family.

19. The system of claim 17, wherein the rules execution module executes multiplicity identification rules for one or more of said plurality of types associated with a link meta-type.

20. The system of claim 17, wherein the graphical diagram includes a business model representing a business entity, a business issue, a business problem, a business process, a business strategy, or combinations thereof.

21. The system of claim 17, wherein the module is further operable to execute one or more type identifying rules on the graphical diagram and collect identified types from the step of executing said one or more type identifying rules.

22. The system of claim 21, wherein said module is further operable to use a supervised learning to extract a model family associated with the graphics diagram to derive said one or more predetermined meta-types.

23. The system of claim 17, wherein the module identifies a plurality of types using a probabilistic method, the probabilistic method including selecting one rule for type identification, said one rule being most inclusive rule when more than one rule identifies same set of types.

24. The system of claim 17, wherein the module identifies a plurality of types by building a collection of trees, each tree corresponding to a specific order of criteria; reducing average height of the trees; reducing number of trees in the collection of trees by using one or more business rules; selecting a candidate tree from said reduced collection of trees using a predetermined method; and outputting one or more top level nodes of the candidate tree, the top level nodes corresponding to meta-model types.

25. A program storage device readable by a machine, tangibly embodying a program of instructions executable by the machine to perform a method of identifying graphical model semantics, comprising:
receiving a graphical diagram;
associating each of a plurality of elements from the diagram with one or more predetermined meta-types;
identifying a plurality of types in the graphical diagram;
determining a category for each of elements in said graphical diagram;
executing containment identification rules to identify one or more containment relationships in the graphical diagram;
executing multiplicity identification rules to identify multiplicity relationships in the graphical diagram; and
executing advanced semantic rules to identify visual elements that represent attributes and refine relationships between the plurality of types to identify unique behavior.
